(19) United States
(12) Patent Application Publication
(10) Pub. No.: US 2018/0201831 A1
(43) Pub. Date: Jul. 19, 2018

(54) A METHOD OF FORMING OXIDE QUANTUM DOTS AND USES THEREOF

(71) Applicants: Newsouth Innovations Pty Limited, Sydney - New South Wales (AU); Fuzhou Danlaw Xicheng Electronic Technology Co. Ltd., Fuzhou (CN)

(72) Inventors: Sean Suixiang LI, Turramurra - New South Wales (AU); Dewei CHU, Lindfield - New South Wales (AU); James Robert HENDERSON, East Ryde - New South Wales (AU)

(73) Assignees: Newsouth Innovations Pty Limited, Sydney - New South Wales (AU); Fuzhou Danlaw Xicheng Electronic Technology Co. Ltd., Fuzhou (CN)

(21) Appl. No.: 15/748,334

(22) PCT Filed: Jul. 29, 2016
(86) PCT No.: PCT/AU2016/050686

§ 371 Date: Jan. 29, 2018

(30) Foreign Application Priority Data
Jul. 29, 2015 (AU) 2015903020

(51) Int. Cl. C09K 11/02; C09K 11/66; H05B 3/86

(52) U.S. Cl. CPC C09K 11/02; B82Y 30/00; H05B 3/86; C09K 11/661

(57) ABSTRACT

A method of forming oxide quantum dots is disclosed. The method may provide for the highly controlled formation of the oxide quantum dots. A composition comprising oxide quantum dots is also disclosed. The oxide quantum dots may be considered to be highly crystalline, allowing the oxide quantum dots and composition to be utilised at ambient conditions without requiring subsequent high temperature calcination. The transparent and conductive oxide quantum dots may find particular application in the large scale coating of a variety of substrates, including silicon, glass, polymers, or composites, etc., and may be used in windscreens, or windows of vehicles (such as automobiles, trains, aeroplanes, etc.) and/or buildings, etc., which require conductive capabilities, such as for the purposes of de-fogging or de-icing.

### TECHNICAL FIELD

A method of forming oxide quantum dots is disclosed. A method of forming a transparent conductive oxide film on a substrate is also disclosed. The transparent conductive oxide film may comprise the oxide quantum dots formed by the disclosed method. The transparent conductive oxide film disclosed herein may provide the ability to coat larger substrates than previously possible, or substrates on a larger scale than previously possible, or flexible substrates, or irregularly shaped substrates (such as concave or convex substrates), as the transparent conductive oxide film can be deposited onto the substrate at lower temperatures, such as at ambient temperatures, than known technologies allow. As such, the oxide quantum dots and transparent conductive oxide film disclosed herein may find particular application, although is not so limited, in the large scale coating of windscreens, or windows of vehicles (such as automobiles, trains, aeroplanes, etc.) and/or buildings, etc., which require conductive capabilities, such as for the purposes of de-fogging or de-icing.

### BACKGROUND ART

Some materials, when quite small, have been known to exhibit new properties, such as quantum effects. Usually, these materials will be less than about 10 nanometers and may be referred to as ‘quantum dots’. Such quantum dots can be formed as thin films deposited onto a substrate by a number of techniques including physical vapour deposition (PVD), chemical vapour deposition (CVD) and chemical synthesis.

Currently. PVD and CVD techniques require the use of complex and expensive vacuum chambers, which severely limits the substrate size to which such thin films can be deposited. Chemical synthesis techniques usually require high temperature calcination (˜500° C.) to achieve high performance materials with a high degree of crystallinity. This limits the type of substrates that can be used, and can cause cracking induced by the different rates of thermal expansion between the coating materials and substrates during high temperature calcination which can degrade the performance of the materials.

Fogging and icing on condensed matter materials, such as glass, due to the condensation of moisture in the air can be quite problematic. Due to the size/dimensions of materials used in applications in which fogging and icing is a problem (e.g. windscreens), there are serious limitations on the types of techniques that can be used in an attempt to counter these problems. As such, it has generally been necessary to utilise non-transparent conductive materials in these large-scale applications.

The above references to the background art do not constitute an admission that the art forms a part of the common general knowledge of a person of ordinary skill in the art. The above references are also not intended to limit the application of the methods, substrate and use of a substrate as disclosed herein.

### SUMMARY

According to a first aspect, a method of forming oxide quantum dots is disclosed. The method disclosed herein may provide for the highly controlled formation of the oxide quantum dots.

The method comprises providing precursor materials for forming oxide quantum dots and dissolving the precursor materials in a first liquid. Nucleation of the oxide quantum dots is promoted in the first liquid. A second liquid is also provided. The second liquid and the first liquid are added to form a liquid composite. A liquid composite, in the context of this specification, simply refers to the combination of two or more liquids. The liquids may be immiscible, forming an interface between the two or more liquids (i.e. a layered multiphasic liquid), or miscible, where no interface is formed and the two or more liquids are substantially co-mingled (i.e. a substantially homogeneous mixing of the two or more liquids occurs). Growth of the oxide quantum dots in the liquid composite can then be controlled, providing the ability to control the size, crystallinity, surface defects, morphology and dispersibility of the resulting quantum dots.

Various oxide quantum dots may be formed, such as indium tin oxide (ITO), fluorine-doped tin oxide (FTO), aluminium-doped zinc oxide (AZO), boron-doped zinc oxide (BZO), strontium ruthenium oxide (SRO), and some conductive polymers. As will be understood by those skilled in the art, various precursors may be used to achieve the required quantum dots. For example, the precursor materials may contain SnCl₂ and In(NO₃)₃ for forming ITO, SnCl₂.H₂O and NH₄F for forming FTO, AlCl₃ and Zn(CH₃COO)₂.2H₂O for forming AZO, and B(OCH₃)₃ and Zn(CH₃COO)₂.2H₂O for forming BZO. Although, it should be appreciated that other precursor materials may be employed to obtain the same oxides. For example. SnCl₄ may be substituted for SnCl₂ and ITO will still be formed, or Al(NO₃)₃ or Al(O-i-Pr)₃ (Al-isopropoxide) may be substituted for AlCl₃ and AZO will still be formed. Similarly, substitutions to the precursors identified here are also known, and envisaged. For simplicity purposes, further reference to oxide quantum dots, and precursors for forming the oxide quantum dots, will be made with respect to SnCl₂, or SnCl₄, and In(NO₃)₃ for forming ITO. Furthermore, it will also be appreciated that the, or each of the, precursor materials may be independently dissolved in the first liquid (or a portion thereof) and the portions combined, or one of the precursor materials may be dissolved in the first liquid and another of the precursor materials may be subsequently added and dissolved. As such, it will also be appreciated that the precursor materials need not be simultaneously dissolved in the first liquid.

In some forms, the first liquid may be an aqueous liquid, such as pure water.

In some forms, the second liquid may be an organic liquid, such as ethanol, triethylene glycol, ethylene glycol, hexane, or toluene, etc. The organic liquid employed may be selected based on its interaction with one or more of the precursor materials. For example, an organic liquid with a specific dielectric constant that favours decomposition of a precursor material may be selected. In this regard, the organic liquid may decrease the decomposition temperature of a precursor material compared to the precursor material in aqueous solution. Further, the organic liquid may assist in controlling the doping level, shape, and/or the size, of the resultant oxide quantum dots.

In some forms, the second liquid may be miscible in the first liquid. For example, the first liquid may be water, and the second liquid may be ethanol or triethylene glycol, etc.

In some forms, the second liquid may be immiscible in the first liquid. For example, the first liquid may be water, and the second liquid may be toluene, or another liquid immiscible in water. In this regard, the liquid composite may be considered to be a multiphasic liquid. The liquid-liquid interface between the immiscible liquids allows the nucleation and growth processes to be separated, thereby enabling greater crystal size, higher doping level, morphology, crystallinity and dispersibility control. At any rate, in this form, the first and second liquids are added together to form the liquid composite.

In some forms, a surfactant may be added to the liquid composite. The surfactant may assist in controlling the doping level, size and/or morphology of the oxide quantum dots. For example, the surfactant may be absorbed onto the surface of the oxide quantum dots and prevent further growth or agglomeration of the oxide quantum dots. Suitable surfactants may include oleic acid, polyvinylpyrrolidone (PVP), etc., but are not so limited.

In some forms, an alkali may be added to the liquid composite. The alkali may assist in decreasing the decomposition temperature of a precursor material. Suitable alkali's may include NaOH, NH₄OH, tert-butylamine, etc., but are not so limited. A stronger alkali may be preferred, which may assist in reducing the precursor materials to the preferred oxide. In this regard, in some forms NaOH, a stronger alkali than NH₄OH, may be preferred.

In some forms, the method may further comprise treating the liquid composite at an elevated temperature. The temperature may be elevated to between about 50° C. and 300° C., although in some forms the temperature may be elevated even higher. In another form, the method may further comprise treating the liquid composite at an elevated pressure. The pressure may be elevated to between about 1 MPa and 20 MPa. In one form, the liquid composite may be treated at both an elevated temperature and pressure. Such a treatment is generally known as autoclaving.

Treatment of the liquid composite, be that at temperature and/or pressure, may occur over a duration of between about 1 hour and 72 hours. Also, it should be appreciated that altering the treatment conditions (including temperature, pressure and/or treatment duration) that the liquid composite may be subjected to may influence the size, morphology and dispersibility of the oxide quantum dots.

In some forms, subsequent to treatment of the liquid composite, the liquid composite may be extracted for further processing. This further processing may be to further purify the oxide quantum dots. For example, and in one form, the further processing may comprise centrifuging the liquid composite to obtain a powder of the oxide quantum dots (and to separate the oxide quantum dots from any of the first or second liquids).

In forms where the first and second liquids of the liquid composite are immiscible and the liquid composite forms as a multiphasic liquid, this further processing may include extracting the second liquid for further processing. For example, in one form the further processing may comprise centrifuging the second liquid to obtain a powder of the oxide quantum dots (and to separate the oxide quantum dots from any of the remaining first or second liquids).

In some forms, the powder (i.e. those oxide quantum dots that are separated during the centrifuging step) may be further purified by washing. For example, the powder may be washed with ethanol to remove any excess water, organic solvents and surfactants. The washing step may be performed more than once. Once washed, a purified powder of oxide quantum dots remains.

The powder or purified powder may be dispersed in a solvent to form a transparent sol comprising said oxide quantum dots. In order to adequately disperse the powder into the solvent, it may be necessary to perform further processing, such as ultrasonication. In addition to further processing techniques, a surfactant may be added to the sol to improve the dispersivity of the powder in solution. It is believed that the surfactant can modify the surface tension of the solvent and promote self-assembly of the oxide quantum dots at the liquid-air interface (i.e. at the air-surface interface of the liquid).

It should also be appreciated that, in some forms, it may not be necessary to purify the oxide quantum dots (as described above). For example, the liquid composite after treatment may be in format suitable for utilisation of the oxide quantum dots. In forms where the first and second liquids of the liquid composite are immiscible, for example, it may be possible to extract the second liquid (already comprising the oxide quantum dots) from the treated liquid composite and utilise the extracted second liquid without further processing.

In some forms, the oxide quantum dots may be deposited onto a substrate to form a transparent conductive oxide film. For example, the resulting transparent sol, or extracted second liquid, (as described above) may be deposited/coated onto the substrate to form the transparent conductive oxide film. In this regard, the oxide quantum dots may act as transparent electrical conductors in the transparent conductive oxide film. The transparent conductive oxide film may be connected to a power supply via electrical connectors, thereby forming an electrical circuit. When current is applied, the transparent conductive oxide film conducts electricity.

Substrates may include condensed matter materials, such as silicon, glass, polymers, or composites, etc. The substrates may be relatively rigid or relatively flexible. As will become apparent, below, the transparent conductive oxide film presently disclosed allows for much larger scale production processes to be employed than is currently available using known techniques for preparing transparent conductive oxide films. One such application may be the use of transparent conductive oxide films on a transparent substrate, such as the large scale production of windscreens or windows of vehicles (such as automobiles, trains, aeroplanes, etc.) and/or buildings, etc., which require conductive capabilities, such as for the purposes of de-fogging or de-icing. This may include depositing the quantum dots directly onto the windscreen or window, or may include depositing (e.g. printing) the quantum dots onto a plastic/polymer with an adhesive backing, to allow the plastic/polymer to be adhered to the windscreen or window (e.g. retrofit to an existing windscreen or window).

Conductive oxide films prepared using known PVD and CVD techniques require the use of complex and expensive vacuum chambers. This severely limits the substrate size to which such thin films can be deposited. Conductive oxide films prepared using chemical synthesis techniques usually require high temperature calcination (˜500° C.) to achieve high performance materials with a high degree of crystallinity. This severely limits the type of substrates that can be used. However, no such limitations are encountered when the oxide quantum dots disclosed herein are deposited onto a substrate to form a transparent conductive oxide film (such as for a patterned electric circuit). As the oxide quantum dots can be deposited onto the substrate at ambient conditions, the substrate can be of any required size (i.e. the size of the substrate is not limited due to the size of the vacuum chamber). Additionally, as no high temperature calcination stage is required subsequent to depositing the oxide quantum dots onto the substrate, substrates which have typically been avoided because of their inability to withstand high temperature processing, including various polymers such as polyethylene terephthalate (PET), polymethyl methacrylate (PMMA), etc., or composites may now be used. This can also allow oxide quantum dots to be deposited onto flexible substrates which, for similar reasons, were unable to be used. Further, as a larger variety of substrates can be employed, and larger/bigger substrates can be deposited onto, the technology may be employed in a wider assortment of industries.

Additionally, the use of a transparent conductive oxide film as disclosed herein may provide an advantage over known non-transparent conductive films, such as the metal conductive films used in the automotive glass industry. The non-transparent films are required to have minimal surface area in contact with the substrate, to minimize the extent to which the vision of, for example, a driver may be obscured. As such, a relatively thick coating of the non-transparent materials may be required to ensure adequate conductivity over a minimal surface area (otherwise the non-transparent material may obscure the vision of the driver). It should also be noted that in some instances, the non-transparent film may be formed as a laminate in the glass. However, due to the difference in thermal expansion coefficients of the non-transparent materials and substrate (e.g. glass), this may result in internal strain which weakens the mechanical properties of the glass, and may even cause delamination.

In some forms, the oxide quantum dots of the present disclosure may have a thermal expansion coefficient much closer to that of the substrate (such as for glass or other oxide substrates) onto which they are being deposited. In this regard, the oxide quantum dots of the present disclosure are much less likely to weaken the mechanical properties of the substrate. Additionally, as no high temperature calcination is required subsequent to depositing the oxide quantum dots onto the substrate, there is a reduced likelihood of the materials performance being degraded due to induced by the different rates of thermal expansion between the coating materials and substrates.

In some forms, the oxide quantum dots may be deposited onto the substrate in a specific configuration, such as a decoration, shape or pattern so that a transparent conductive oxide film may be formed in the specific configuration. In this regard, the oxide quantum dots may be deposited onto the substrate to form a transparent conductive oxide film in the shape of a logo or message, such that as the condensation, fog or ice is being cleared, the message or logo appears on the substrate. In this regard, the transparent conductive oxide film (i.e. the oxide quantum dots) may be connected to a power supply via electrical connectors, thereby forming an electrical circuit. When current is applied, the transparent conductive oxide film (i.e. the oxide quantum dots) conducts electricity, causing localised heating of the substrate and clearing the condensation, fog or ice in the shape/pattern of the logo or message.

In another embodiment, the quantum dots may be deposited onto the substrate as two, or more, isolated, or discrete, transparent conductive oxide films (e.g. as two separate conductive circuits). This may allow the two discrete films to be heated at different rates, resulting in the condensation, fog or ice being cleared at different rates in the vicinity of the two discrete films. For example, the two discrete films may be formed from different materials (i.e. from different oxide quantum dots having different resistivities/conductivities), be formed from the same material with the two discrete films having different thicknesses (and thus different resistivities/conductivities), or have the current applied thereto at different times. This can provide a versatile system for conveying messages, even if only for a limited time. Although, it should be appreciated that the message may be conveyed a number of times. For example, if the substrate were to become re-fogged or re-iced, the message may be conveyed again during a subsequent de-fogging or de-icing process.

Prior to the oxide quantum dots being deposited onto the substrate, the substrate may be pre-treated to reduce its surface energy. For example, the surface of the substrate may be cleaned (e.g. by deionized water, ethanol, acetate, etc.), or the substrate may be pre-treated by, for example, UV-irradiation, or a combination of the pre-treatments may be utilised. Reduction of the surface energy of the substrate is believed to enlarge the liquid-air interface (i.e. as the liquid spreads out on the substrate surface), which may result in a thinner, more uniform film being formed.

In some forms, the transparent conductive oxide film may be dried on the substrate at ambient conditions. In other forms, the transparent conductive oxide film may be dried by UV-irradiation. It should be appreciated that a combination of the drying forms may be utilised. This is contrary to current chemical methods associated with forming transparent conductive oxide films, whereby high temperature calcination (˜500° C.) is required. As no high-temperature calcination step is required subsequent to the transparent conductive oxide film being deposited onto the substrate in the present disclosure, a wider assortment of materials can be used as the substrate. For example, in addition to glasses, other transparent materials such as silicon, polymers or composites may be employed. Additionally, as no high temperature calcination is required, cracks due to shrinkage may also be minimized or avoided. This can also provide significant cost savings, when compared to known techniques.

In some forms, the oxide quantum dots may be further deposited onto the substrate to form a thicker transparent conductive oxide film. In this regard, multiple layers of the transparent conductive oxide film may be deposited onto the substrate. In some forms, these layers may be deposited directly onto the first layer/film of transparent conductive oxide. In other forms, these layers may be deposited onto the first (or preceding) layer/film of transparent conductive oxide only after the preceding layer has been dried. For example, the drying techniques identified above may be employed between the deposition of layers. Thicker transparent conductive oxide films may be preferred if a higher conductivity is required, or if regions of different conductivity are required. In some forms, the quantum dots may be further deposited onto the substrate to form a second transparent conductive oxide film that is discrete from the first transparent conductive oxide film (e.g. as two separate conductive circuits). In the case of discrete films, the application of current may be varied between the two discrete films, or may be time delayed. This may allow a message, pattern, logo. etc. to be displayed on the substrate as it is being de-fogged or de-iced, etc.

In some forms, the oxide quantum dots may be deposited using ink-jet printing, spray printing, spin-coating, slot die coating, doctor blade coating, screen-printing/coating, gravure printing/coating, engraved roller printing/coating, commabar printing/coating, micro-roller printing/coating, nano-imprint printing, bar spreading, dip-coating, contact coating, non-contact coating, or a combination thereof. Such deposition techniques allow the oxide quantum dots to be deposited on large scale substrates, without being limited to the size of the chamber that would otherwise be required using known CVD, PVD or chemical synthesis techniques. Additionally, such deposition techniques may provide a significant cost savings when compared with known CVD, PVD or chemical synthesis techniques.

It should be appreciated that many other forms, for depositing the oxide quantum dots onto the substrate, are well within the knowledge of the skilled addressee, and thus form part of the methods available to employ the method disclosed herein, even if the deposition methods themselves are not explicitly herein defined.

According to a second aspect, a method of forming a transparent conductive oxide film on a substrate is disclosed. The method comprises reducing the surface energy of the substrate, providing quantum dots of the transparent conductive oxide, and depositing the quantum dots onto the substrate to form a transparent conductive oxide film. As identified above, it is believed that by reducing the surface energy of the substrate the liquid-air interface is enlarged (i.e. the liquid/sol spreads out on the substrate surface), which may result in a thinner, more uniform film being formed. In one form, reducing the surface energy of the substrate may comprise UV-irradiating the substrate, and/or other cleaning of the substrate surface.

The transparent conductive oxide film (i.e. the oxide quantum dots) may form an electrical circuit. The transparent conductive oxide film (i.e. the oxide quantum dots) may be connected to a power supply via electrical connectors, thereby forming the electrical circuit. When current is applied, the transparent conductive oxide film (i.e. the oxide quantum dots) conducts electricity.

In some forms, prior to their deposition onto the substrate, the surface tension of the quantum dots may be modified. For example, the quantum dots may be provided in the form of a sol (a colloidal/suspension solution of the quantum dots). As previously hypothesised, it is believed that modifying the surface tension of the sol can encourage concentration of the quantum dots at the liquid-air interface (i.e. at the air-surface interface of the liquid).

In some forms, the transparent conductive oxide film may be dried at ambient conditions. In other forms, the transparent conductive oxide film may be dried by UV-irradiation. In either form, or in a combination of the forms, this is still contrary to current chemical methods associated with forming transparent conductive oxide films, whereby high temperature calcination (˜500° C.) of the film on the substrate is required. Eliminating the high-temperature calcination step which is usually required subsequent to the transparent conductive oxide film being deposited onto the substrate, a wider array of materials can be used as the substrate in the present disclosure. For example, in addition to glasses, other transparent materials such as silicon, polymers or composites may be employed. Additionally, as no high temperature calcination is required, cracks due to shrinkage may also be minimized or avoided.

As indicated above, the quantum dots may be deposited using ink-jet printing, screen-printing/coating, gravure printing/coating, engraved roller printing/coating, commabar printing/coating, micro-roller printing/coating, nano-imprint printing, spray printing, spin-coating, slot die coating, doctor blade coating, bar spreading, contact coating, dip coating, non-contact coating, or a combination thereof, although other depositing techniques are also envisaged. This may provide a low-cost, large scale production alternative to known CVD, PVD and chemical synthesis techniques.

Additionally, and as already identified in relation to the first aspect, the method disclosed herein provides a versatile method that can be employed in a number of different ways, for use in a number of different industries, with a number of different outcomes. As such, this versatility will not be outlined again here in detail, however, it should be appreciated that comments provided in relation to the first aspect are equally relevant to this second aspect, and other aspects disclosed herein. In this regard, the method of the second aspect may be otherwise as defined in the first aspect.

Also disclosed herein is a substrate comprising a transparent conductive oxide film as defined in the second aspect. The transparent conductive oxide film may be formed from oxide quantum dots formed according to the method as defined in the first aspect. In this regard, the transparent conductive oxide film (i.e. the oxide quantum dots) may form an electrical circuit on the substrate. The transparent conductive oxide film (i.e. the oxide quantum dots) may be connected to a power supply via electrical connectors, thereby forming the electrical circuit. When current is applied, the transparent conductive oxide film (i.e. the oxide quantum dots) conducts electricity, which may cause localised heating of the substrate.

In some forms, the substrate may be transparent. The use of a transparent conductive oxide film with a transparent substrate enables the present disclosure to be employed in a number of industrial and commercial applications. For example, the substrate may be employed as a windscreen, windshield, window or glass pane. The glass panes may also be employed in the fabrication of mirrors. The methods disclosed herein allow the substrate with a transparent conductive oxide film to be much larger in size than would be available using known CVD, PVD and chemical synthesis techniques. With no limitations on substrate size being imposed, and low cost deposition methods being available, large scale production for a variety of applications becomes commercially viable.

The ability to form a transparent conductive oxide film on large scale substrates, using low-cost deposition methods, can also provide an alternative to non-transparent conductive films currently used in, for example, the automotive industry. Unlike non-transparent conductive films, the transparent conductive oxide films disclosed herein can be deposited over a significant surface area of the substrate (e.g. a substantial portion of a vehicle's front, rear or side window) without inhibiting driver vision.

For example, the transparent conductive oxide film may be used to heat the substrate to act as an anti-fog or anti-ice for the substrate (i.e. preventing fog or ice forming on the substrate), or to de-fog or de-ice the substrate (i.e. a substrate that has already become fogged or iced). In this regard, the transparent conductive oxide film (i.e. the oxide quantum dots) may be connected to a power supply via electrical connectors, thereby forming an electrical circuit. When current is applied, the transparent conductive oxide film (i.e. the oxide quantum dots) conducts electricity, causing localised heating of the substrate and clearing the condensation, fog or ice in the shape/pattern of the logo or message. The transparent conductive oxide film may allow a greater surface area of the substrate to be deposited with the film, as safety concerns with needing to ensure that it is still possible to see out of the e.g. window, windshield, are no longer an issue.

In another form, the transparent conductive oxide film may act as an electromagnetic frequency receiver (i.e. an antenna). This may enhance the receiving capabilities for various frequency electromagnetic waves, which may improve radio, television, or mobile telephone (cell) reception, etc., depending on the application required. For example, when used as a film on an automotive window, the film may act as an antenna to improve the radio and digital information reception.

In another form, the transparent conductive oxide film may act as an electrode, such as for touch screens and displays.

In a further aspect, a composition comprising oxide quantum dots dispersed in a solvent is also disclosed herein. In this regard, the oxide quantum dots are crystalline. The oxide quantum dots may be considered to be highly crystalline. As the oxide quantum dots are highly crystalline, the composition can be utilised at ambient conditions without requiring subsequent high temperature calcination. The oxide quantum dots may be thought of as nano-crystals with high crystallinity. The oxide quantum dots also have good conductivity and good transparency. The selection of specific solvents may enable the decomposition of oxide at a lower (relatively) temperature, and result in highly crystalline quantum dots. Growth of the quantum dots can also be controlled/confined. As the particle size of the quantum dots is small, close packing and dense films can be achieved. Thus, the films are highly transparent and conductive.

In some forms, the composition may further comprise a surfactant. The surfactant may be added to the composition to improve the dispersivity and stability of the oxide quantum dots in the solvent. It is believed that the surfactant can decrease the surface tension of the solvent and promote self-assembly of the oxide quantum dots at the liquid-air interface (i.e. at the air-surface interface of the liquid).

The composition may be utilised as an ink in the printing of transparent conductive oxide films. For example, the ink may be applied using ink-jet printing, screen-printing/coating, gravure printing/coating, engraved roller printing/coating, commabar printing/coating, micro-roller printing/coating, nano-imprint printing, spray printing, spin-coating, slot die coating, doctor blade coating, bar spreading, contact coating, dip coating, non-contact coating, or a combination thereof, although other application techniques are also envisaged. Such films can be printed at ambient conditions, without requiring subsequent high temperature calcination. Such films can have good conductivity, whilst maintaining good transparency.

A substrate comprising a transparent conductive oxide film is also disclosed. The film comprises oxide quantum dots that are crystalline. The oxide quantum dots may be considered to be highly crystalline. As the oxide quantum dots are highly crystalline and highly self-assembled, the film can be utilised at ambient conditions without requiring subsequent high temperature calcination, whilst still achieving good conductivity.

The oxide quantum dots may be applied to the substrate dispersed in a solvent. The oxide quantum dots may be crystalline prior to being dispersed in the solvent. In this regard, the oxide quantum dots may be applied using ink-jet printing, screen-printing/coating, gravure printing/coating, engraved roller printing/coating, commabar printing/coating, micro-roller printing/coating, nano-imprint printing, spray printing, spin-coating, slot die coating, doctor blade coating, bar spreading, contact coating, dip coating, non-contact coating, or a combination thereof although other application techniques are also envisaged.

The substrate may comprise silicon, glass, polymers or composites, etc. The substrate may also be transparent.

The transparent conductive oxide film (i.e. the oxide quantum dots) may form an electrical circuit on the substrate. The transparent conductive oxide film (i.e. the oxide quantum dots) may be connected to a power supply via electrical connectors, thereby forming the electrical circuit. When current is applied, the transparent conductive oxide film (i.e. the oxide quantum dots) conducts electricity, which may cause localised heating of the substrate.

The oxide quantum dots may be deposited onto the substrate in a specific configuration, such as a decoration, shape or pattern so that the film may be formed in that specific configuration. In this regard, the film may be formed in the shape of a logo or message, or circuit. In this regard, the film (i.e. the oxide quantum dots) may be connected to a power supply via electrical connectors and, when current is applied, the film (i.e. the oxide quantum dots) conducts electricity, causing localised heating of the substrate and clearing the condensation, fog or ice in the shape/pattern of the logo or message.

The substrate may be a windscreen, mirror, window, or the like. As above, current can be applied to the film such that condensation, fog or ice that formed on the substrate is cleared. When the film is in the shape of a logo, message or circuit, the logo, message or circuit appears on the substrate.

Whilst some applications have been disclosed herein, some in greater detail than others, it should be appreciated that due to the larger scale production capabilities, few if any limitations being imposed on substrate size, low production cost and assortment of substrates that are available using this technology (which were previously unsuitable), other applications are envisaged.

### BRIEF DESCRIPTION

Notwithstanding any other forms that may fall within the scope of methods, substrate and use thereof as set forth in the Summary, specific embodiments will now be described, by way of example only, with reference to the accompanying drawings in which:

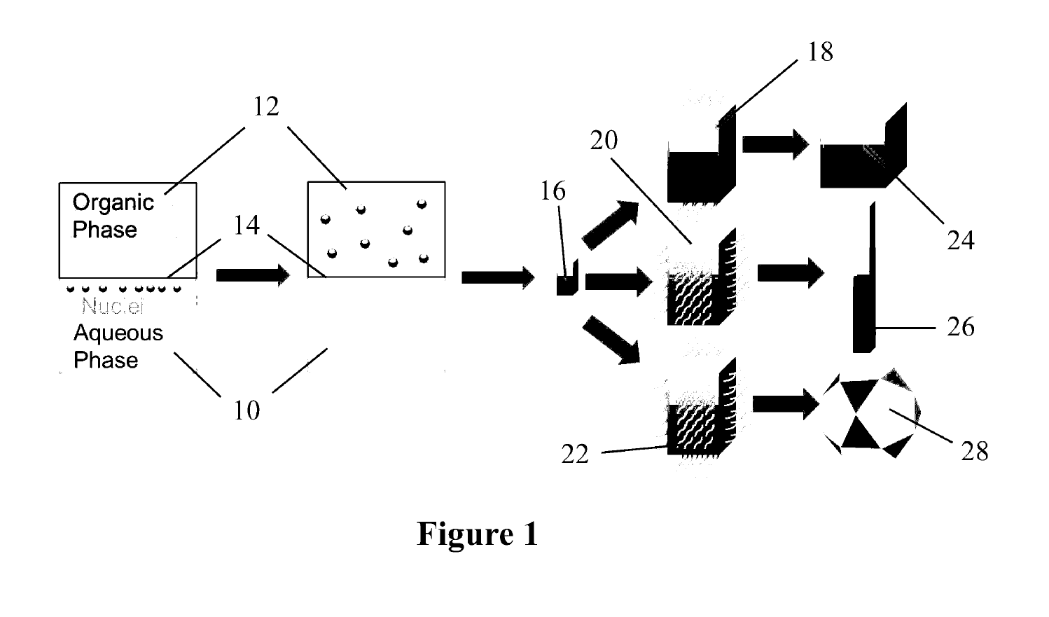

FIG. 1 shows a schematic illustration of an embodiment of a growth mechanism of quantum dots;

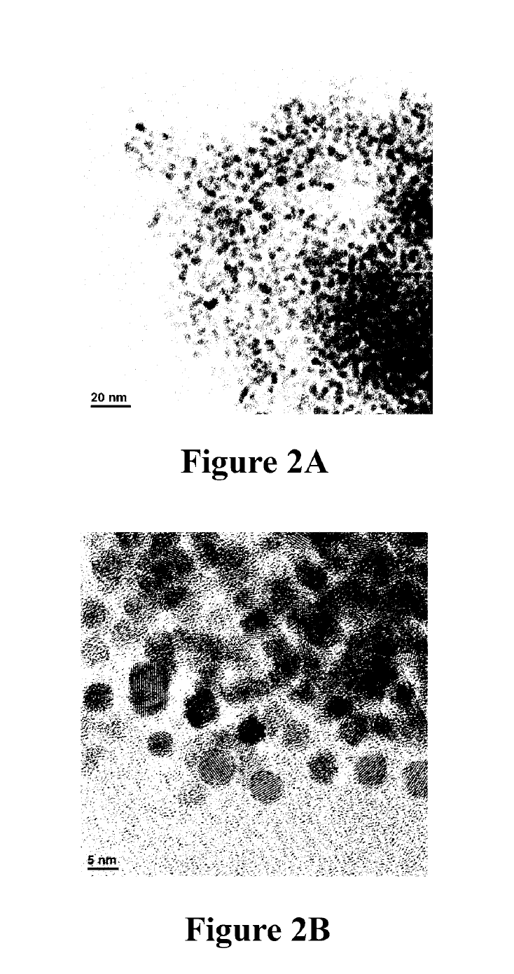

FIGS. 2A and 2B show images of 10 wt % Sn doped In₂O₃ quantum dots prepared in accordance with a first embodiment;

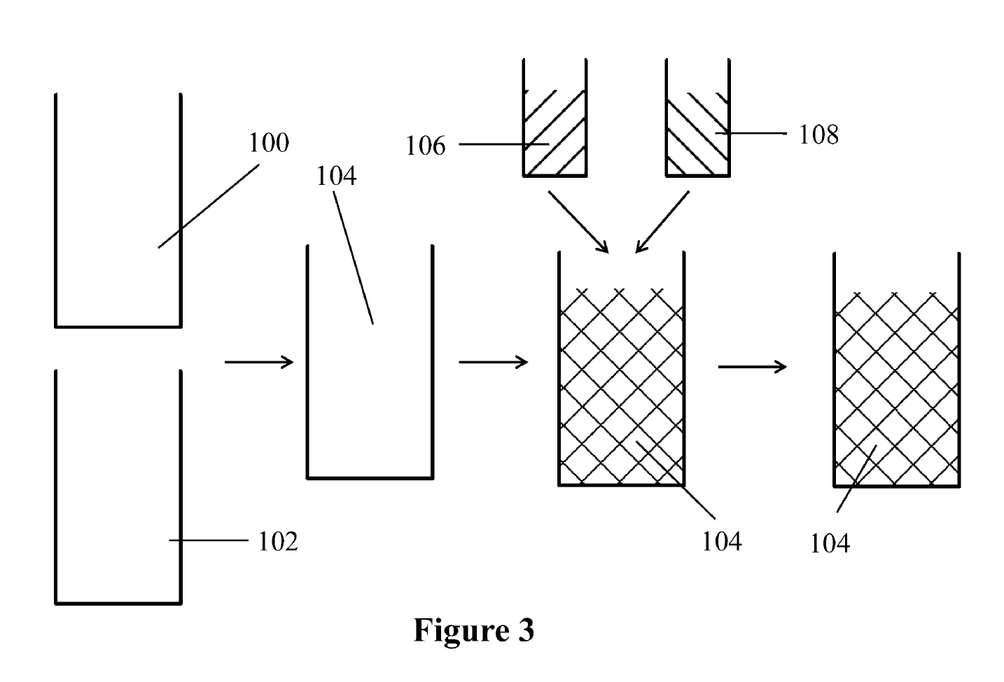

FIG. 3 shows a schematic illustration of an embodiment of a growth mechanism of quantum dots;

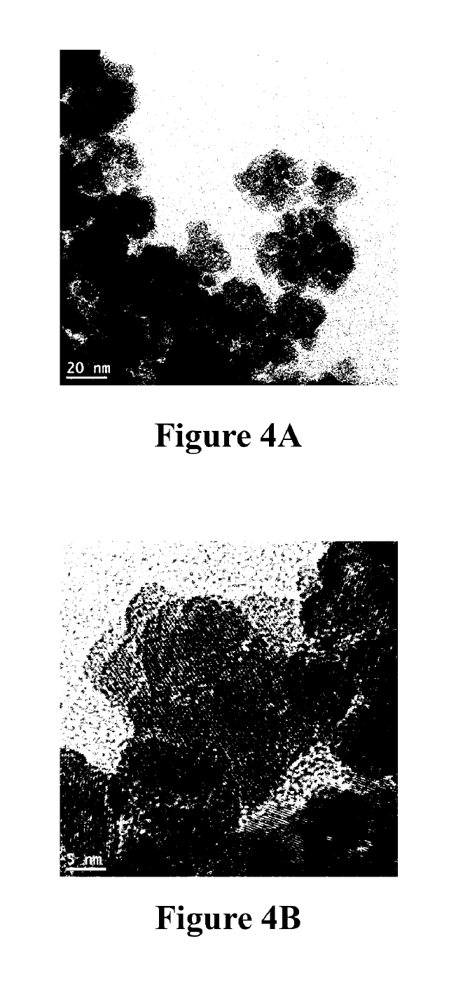

FIGS. 4A and 4B show images of 10 wt % Sn doped In₂O₃ quantum dots prepared in accordance with a second embodiment;

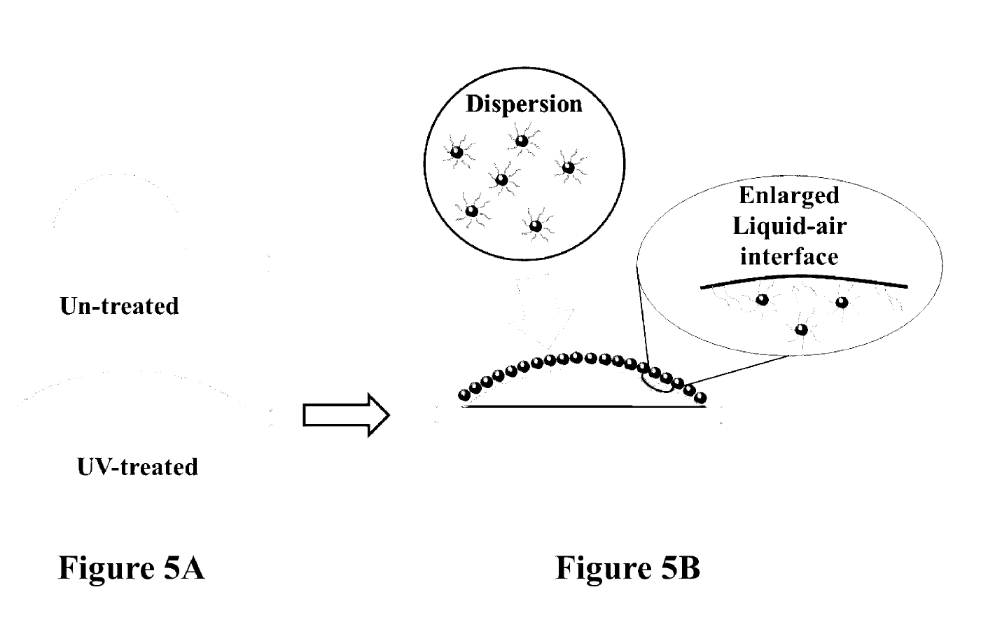

FIGS. 5A and 5B show schematic illustrations of the formation of quantum dots at an enlarged liquid-air interface; and

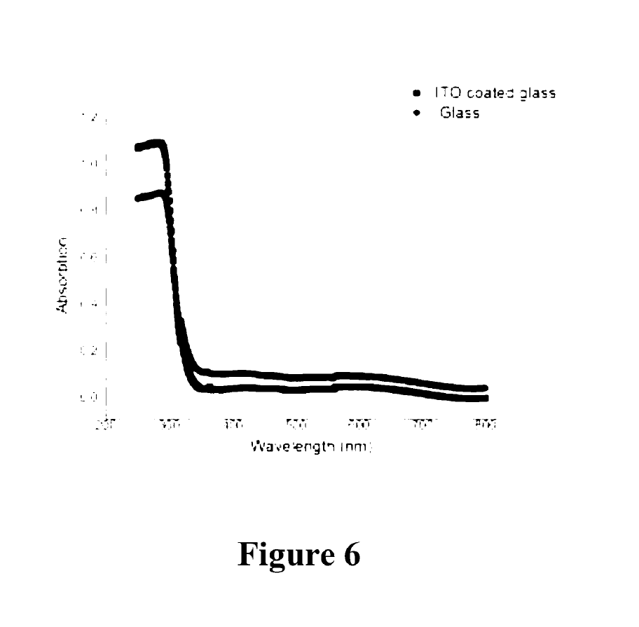

FIG. 6 shows UV-visible spectra of 10 wt % Sn doped In₂O₃ quantum dots and bare glass substrate.

### DETAILED DESCRIPTION

Referring firstly to FIG. 1, a general schematic illustration of an embodiment of the growth mechanism of quantum dots, as disclosed herein, is shown. The schematic illustration shown in FIG. 1 emphasises the role that separating the nucleation and growth processes has on the ability to control the size, morphology and dispersibility of the resulting oxide quantum dots.

In FIG. 1, the precursor materials (e.g. SnCl₂ and In(NO₃)₃ in a weight ratio of 10:90) is shown as already having been added to the first liquid which, in this embodiment, is an aqueous phase 10 of deionized water. It should be noted that the precursor materials may be varied. For example, SnCl₄ may be substituted for SnCl₂. In some forms, SnCl₄ may provide more control over the resulting oxide quantum dot morphology and may be preferred over SnCl₂. This is in part because Sn²⁺ (SnCl₂) can be oxidised to Sn⁴⁺ (SnCl₄), making it less stable than Sn⁴⁺.

The aqueous phase 10 had a second liquid added onto it which, in this embodiment, is an organic liquid 12, toluene. Organic liquid 12 is immiscible in aqueous phase 10, forming a liquid composite in the form of a multiphasic liquid comprising a liquid-liquid interface 14 between the aqueous phase and organic liquid. Growth of the oxide quantum dot at the liquid-liquid interface can then be controlled, providing the ability to control the size, crystallinity, morphology and dispersibility of the resulting dot, as shown at 16, 18, 20, 22, 24, 26 and 28. In this regard, the liquid composite was autoclaved at 200° C. for 48 hours.

The autoclave was cooled to room temperature and the top layer of the multiphasic liquid was removed to centrifuge tubes and washed with pure ethanol. This was repeated a further two times, leaving a powder of the oxide quantum dots. FIGS. 2A and 2B show TEM images of the resulting powder of oxide quantum dots. The powder was dispersed in toluene, and ultrasonicated for 3 minutes. A stable, transparent colloidal/suspension solution (sol) of the quantum dots was thus obtained.

Referring now to FIG. 3, a general schematic illustration of an alternative embodiment of the growth mechanism of quantum dots, as disclosed herein, is shown. The first liquid, aqueous phase 100, had a second liquid added to it which, in this embodiment, is the organic liquid 102, ethanol. Other organic liquids may be used, and specific organic liquids may be preferred depending on the precursor materials, the oxide quantum dots being formed, etc. For example, the organic liquid may be selected based on its dielectric constant, which may be used to alter the doping level or size of the oxide quantum dots.

In this embodiment, organic liquid 102 is miscible in aqueous phase 100. As such, and contrary to the embodiment described in relation to FIG. 1, no liquid-liquid interface is formed between the aqueous phase and organic liquid. Nonetheless, a liquid composite 104 comprising the aqueous phase and organic liquid is formed. In this regard, liquid composite merely refers to the combination or mixing of the two (aqueous and organic) liquid types. In order to control growth of the oxide quantum dot, and provide the ability to control the size, crystallinity, morphology and dispersibility of the resulting dot, an alkali 106 and a surfactant 108 were also added to the liquid composite 104.

The liquid composite 104 was autoclaved at 250° C. for 24 hours. The autoclave was cooled to room temperature and the liquid composition was removed to centrifuge tubes and centrifuged. The powder was washed with pure ethanol. This was repeated a further two times, leaving a powder of the oxide quantum dots. FIGS. 4A and 4B show TEM images of the resulting powder of oxide quantum dots. The powder was re-dispersed in toluene, and ultrasonicated for 3 minutes. A stable, transparent colloidal/suspension solution (sol) of the quantum dots was thus obtained.

In order to prepare a glass substrate for deposition of the sol, as described in relation to FIG. 1 or FIG. 3, the glass substrate was cleaned. It should be noted that other substrates, including as polymers such as polyethylene terephthalate (PET) or polymethyl methacrylate (PMMA), may be used. FIG. 5 schematically shows the effect that UV-treating the substrate has on the liquid-air interface of the sol. In FIG. 5A, an untreated substrate and a UV-treated substrate are schematically shown. UV-treating the substrate reduces the surface energy of the substrate, which results in the sol spreading out on the substrate. FIG. 5B shows the quantum dots being drawn to the liquid-air interface and self-assembling in an ordered structure.

Once the sol was dried on the substrate, absorption spectroscopy was conducted on the substrate including the transparent conductive oxide film and a comparative bare glass substrate. The results of this absorption spectroscopy, in relation to the sol prepared according to FIG. 1, is shown in FIG. 6. It can be seen that the substrate including the transparent conductive oxide film shows good optical transparency (i.e. low absorption) in the visible wavelengths (380-750 nm), and improved absorption in the ultraviolet wavelengths (400-100 nm) when compared to the bare glass substrate. Given the prevalence of skin and other damage cause by UV radiation, the additional absorption of this harmful radiation is welcomed, especially in the context of its potential application in the automotive and building industries.

It should also be noted that the resistance of the transparent conductive oxide film can be reduced by increasing the thickness of the film or tuning the level of doping.

### EXAMPLES

Non-limiting Examples of the methods, substrate and the use of a substrate will now be described, with reference to the Figures.

### Example 1—Preparation of 10 wt % Sn Doped in In₂O₃

SnCl₂ and In(NO₃)₃ in a weight ratio of 10:90 were mixed and dissolved in deionized (DI) water (giving a molecular concentration of In³⁺ of 0.1M). The mixed solution was then transferred into an autoclave. An equal amount of toluene was added into the solution in the autoclave, forming a multiphasic liquid, and the autoclave sealed. The autoclave was heated to 200° C. for 48 hours. A schematic illustration of the growth mechanism for oxide quantum dots with different morphologies at the liquid-liquid interface is shown in FIG. 1.

After reaction, the autoclave was cooled to room temperature. The top layer of the solution was removed to centrifuge tubes and washed with pure ethanol. This was repeated a further two times, leaving a powder of quantum dots. Representative TEM images of the resulting 10 wt % Sn doped In₂O₃ quantum dots are shown in FIGS. 2A and 2B.

The powder of quantum dots was dispersed in toluene, and ultrasonicated for 3 minutes. A stable, transparent colloidal/suspension solution (sol) of the quantum dots was thus obtained.

### Example 2—Preparation of 10 wt % Sn Doped In₂O₃ with Improved Dispersivity

The procedure to prepare 10 wt % Sn doped In₂O₃, as described in Example 1, was repeated. In this example, as improved dispersivity of the Sn doped In₂O₃ was required, 1-5 vol % oleic acid was added to the sol obtained in Example 1.

The sol obtained in Example 1 was compared with the sol prepared in this Example by shining a light source through each. In the sol obtained in Example 1 the light was scattered more significantly than the sol prepared in this Example. This indicated that there was more aggregation of the quantum dots in the sol obtained from Example 1 than the sol prepared in this Example (i.e. the sol prepared in this Example had improved dispersivity). It was postulated that this was a result of the surfactant covering the surface of the quantum dots, preventing their aggregation.

### Example 3—Preparation of a Film on Glass Substrate

The sol obtained in Example 2 was to be drop coated or printed onto a glass substrate. Prior to doing so, the glass substrate was cleaned. In this example, glass substrate (Asahi Glass, Japan) was washed firstly with DI water, secondly with ethanol and finally with acetone. The glass substrate was then placed in a UV lamp box (wavelength 260 nm, power 110 W) for 10 minutes of UV treatment, to ensure that the surface of the glass substrate was clean.

An aliquot of 50 microliters was taken from the sol obtained in Example 2, for the purposes of drop coating or printing onto the surface of the glass substrate. Once the quantum dots were drop coated or printed onto the glass substrate, the glass substrate was returned to the UV lamp box for UV treatment for 2 hours, in order to dry the quantum dots onto the glass and to form a uniform and dense film. A schematic illustration showing the formation of quantum dots at an enlarged liquid-air interface is shown in FIG. 5. FIG. 5B also shows schematically what may be considered to be the formation of a self-assembled layer of quantum dots at the enlarged liquid-air interface.

It was noted that, unlike known methods, no further annealing stage was required for the layer/film to form on the surface of the glass substrate. It is understood that this was due to the way in which the sol was prepared.

### Example 4—Testing of Absorption Properties

The procedure to clean a glass substrate, as described in Example 3, was repeated for two glass substrates. One of the glass substrates was then deposited with a film of the 10 wt % Sn doped In₂O₃ sol, as described in Example 3, while the other was left as a bare glass substrate (i.e. with no coating applied).

FIG. 6 shows the results of absorption spectroscopy that was conducted on the substrate including the transparent conductive oxide film and the bare glass substrate. It can be seen that the substrate including the transparent conductive oxide film shows good optical transparency (i.e. low absorption) in the visible wavelengths (380-750 nm), and improved absorption in the ultraviolet wavelengths (400-100 nm) when compared to the bare glass substrate.

### Example 5—Testing of Electrical Properties

Three samples of glass substrates coated with 10 wt % Sn doped In₂O₃ were prepared according to Example 3, excepting that the three samples were prepared so as to have different film thicknesses. In this Example, this was achieved by varying the number of layers of film applied to the glass substrate. Some samples were prepared by depositing each layer directly onto the preceding layer, while it was still ‘wet’. Other samples were prepared by drying each layer of film before the next layer of film was deposited. The samples prepared with intermediary drying stages were found to provide a more uniform film, but this was more time consuming.

It was noted that the resistance of the films can be adjusted by manipulating the thickness of the films or doping level. For example, the sample with the thickest film was observed to have the least resistance, and the sample with the thinnest film was observed to have the most resistance.

### Example 6—Preparation of Multiple Films on a Glass Substrate

The 10 wt % Sn doped In₂O₃ sol prepared in Example 2 was to be used for forming multiple separated circuits (heaters) on a glass substrate by ink-jet printing.

The procedure to clean a glass substrate, as described in Example 3, was repeated. An ink-jet cartridge was at least partially filled with the quantum dots, and the cleaned glass substrate was positioned for printing. Two, discrete, parallel lines were printed onto the glass substrate and the glass substrate was returned to the UV lamp box for UV treatment for 2 hours, in order to dry the quantum dots onto the glass and to form uniform and dense first and second films for use as first and second separated circuits (or heaters).

The first line of film (circuit or heater) was connected to a power supply via electrical connectors mounted on opposite edges of the glass, and the second line of film (circuit or heater) was connected the power supply via separate electrical connectors, also mounted on opposite edges of the glass.

In order to test the de-fogging and de-icing ability of the 10 wt % Sn doped In₂O₃ coated glass substrate, the substrate was subjected to steam, which caused fogging of the substrate surface (i.e. the temperature of the substrate was less than the dew point of the air). Current was then applied to the first electrical connectors (i.e. the electrical connectors connected to the first circuit) and then, approximately 2 seconds later, current was applied to the second electrical connectors (i.e. the electrical connectors connected to the second circuit). As current passed through the first conductive film (circuit), the film became heated causing the condensation to evaporate. For approximately the length of the delay between the application of current to the two circuits (or heaters), the region of the glass substrate that contained the first circuit (or heater) had cleared, whilst the rest of the glass substrate, including the second circuit (or heater), remained fogged. After the current was applied to the second circuit (or heater), the region of the second circuit (or heater) also cleared (i.e. approximately 2 seconds after the first circuit (or heater) had cleared).

In conducting this experiment, it was determined that it would be possible to use different (i.e. separated or isolated) films/circuits to create a logo or message, such that as the condensation, fog or ice is being cleared, the message or logo appears on the substrate. Other than by a time delay on the current application to the separated/isolated films/circuits, this could also be achieved by employing transparent conductive layers that have a different resistivity. In this regard, the same material with different thicknesses for different circuits could be employed, different materials (e.g. having different resistivities) for different circuits could be employed, or a combination of these.

### Example 7—Preparation of 10 wt % Sn doped In₂O₃

SnCl₄.H₂O and In(NO₃)₃.xH₂O in a weight ratio of 10:90 were mixed (giving a molecular concentration of In³⁺ of 0.1M). In this regard, 0.13645 g of In(NO₃)₃ xH₂O and 0.01628 g of SnCl₄ H₂O were mixed. In this Example, unlike in Example 1, the precursor materials (SnCl₄ and In(NO₃)₃) were independently mixed with water. Ethanol and the precursor materials (in water) were mixed by magnetically stirring to form a liquid composite. Once the powders had completely dissolved into the solvents, 0.14350 g of sodium hydroxide (NaOH) was added to the liquid composite. Ig of surfactant, oleic acid, was also added to the liquid composite.

Additional ethanol was added to the liquid composite to make the liquid composite up to 30 mL. The liquid composite was then transferred into an autoclave, and the autoclave sealed. The autoclave was heated to 250° C. for 24 hours.

After reaction, the autoclave was cooled to room temperature. The liquid composite was removed to centrifuge tubes, centrifuged and the powder was washed with pure ethanol. This was repeated a further two times, leaving a powder of quantum dots. Representative TEM images of the resulting 10 wt % Sn doped In₂O₃ quantum dots are shown in FIGS. 4A and 4B.

The powder of quantum dots was dispersed in toluene. A further 10 μl of surfactant (oleic acid) was added, and the solution ultrasonicated for 3 minutes. A stable, transparent colloidal/suspension solution (sol) of the quantum dots was thus obtained.

It will be understood to persons skilled in the art that many other modifications may be made without departing from the spirit and scope of the methods, substrate and use of a substrate as disclosed herein.

In the claims which follow and in the preceding description, except where the context requires otherwise due to express language or necessary implication, the word “comprise” or variations thereof such as “comprises” or “comprising” is used in an inclusive sense, i.e. to specify the presence of the stated features but not to preclude the presence or addition of further features in various embodiments of the methods, substrate and use of a substrate as disclosed herein.

1-49. (canceled)

50. A method of forming oxide quantum dots, the method comprising:
providing precursor materials for forming oxide quantum dots;
dissolving the precursor materials in a first liquid, in which nucleation of the oxide quantum dots is promoted;
providing a second liquid;
adding the second liquid and the first liquid together to form a liquid composite; and
controlling growth of the oxide quantum dots in the liquid composite.

51. The method of claim 50, wherein the first liquid is an aqueous liquid.

52. The method of claim 50, wherein the second liquid is an organic liquid.

53. The method of claim 50, wherein the second liquid is immiscible in the first liquid such that the formed liquid composite is multiphasic and comprises a liquid-liquid interface between the first and second liquids, and whereby growth of the oxide quantum dots is controlled at the liquid-liquid interface.

54. The method of claim 50, further comprising treating the liquid composite at elevated temperature from about 50° C. to about 300° C.

55. The method of claim 50, further comprising treating the liquid composite at elevated pressure from about 1 MPa to about 20 MPa.

56. The method of claim 54 further comprising, subsequent to treating the liquid composite, extracting the liquid composite for centrifuging the liquid composite to obtain a powder of the oxide quantum dots.

57. The method of claim 56, further comprising purifying the powder by washing.

58. The method of claim 56, further comprising dispersing the powder in a solvent to form a transparent sol comprising said oxide quantum dots.

59. The method of claim 58, further comprising depositing the sol onto a substrate to form a first transparent conductive oxide film.

60. The method of claim 59, further comprising depositing the sol onto the substrate to form a second transparent conductive oxide film that is discrete from the first transparent conductive oxide film.

61. The method of claim 59, wherein the sol is deposited using ink-jet printing, spray printing, spin-coating, slot die coating, doctor blade coating, screen-printing/coating, gravure printing/coating, engraved roller printing/coating, commabar printing/coating, micro-roller printing/coating, nano-imprint printing, bar spreading, dip coating, contact coating, non-contact coating, or a combination thereof.

62. A method of forming a transparent conductive oxide film on a substrate, the method comprising:
reducing the surface energy of the substrate;
providing quantum dots of the transparent conductive oxide; and
depositing the quantum dots onto the substrate to form a first transparent conductive oxide film.

63. The method of claim 62, further comprising depositing the quantum dots onto the substrate to form a second transparent conductive oxide film that is discrete from the first transparent conductive oxide film.

64. The method claim 62, further comprising dispersing the quantum dots in a solvent to form a transparent sol comprising said quantum dots, wherein depositing the quantum dots comprises depositing said transparent sol is deposited onto the substrate to form said transparent conductive oxide film.

65. A method of forming a transparent conductive oxide film on a substrate, the method comprising:
reducing the surface energy of the substrate;
providing quantum dots of the transparent conductive oxide; and
depositing the quantum dots onto the substrate to form a transparent conductive oxide film,
wherein the quantum dots are formed according to the method of claim 50.

66. A substrate comprising a transparent conductive oxide film, the transparent conductive film being formed according to the method of claim 50.

67. The substrate of claim 66, wherein the substrate is transparent.

68. A windscreen, windshield, window, or glass pane comprising a substrate according to claim 66.

69. The windscreen, windshield, window, or glass pane of claim 68, wherein the transparent conductive oxide film is adapted to heat the substrate, or to act as an anti-fog or anti-ice for the substrate, or to de-fog or de-ice the substrate.
